(19) United States
(12) Patent Application Publication
(10) Pub. No.: US 2018/0254153 A1
(43) Pub. Date: Sep. 6, 2018

(54) Apparatus for plasma confinement and for ion separation

(71) Applicant: Mikiso Mizuki, Santa Maria, CA (US)

(72) Inventor: Mikiso Mizuki, Santa Maria, CA (US)

(21) Appl. No.: 15/530,793

(22) Filed: Mar. 2, 2017

(51) Int. Cl. H01H 1/10; H01J 49/00; F02B 43/12; C10L 3/00; G21B 1/05

(52) U.S. Cl. CPC H01H 1/10; H01J 49/0031; C10L 2290/40; C10L 3/00; G21B 1/05; F02B 43/12

(57) ABSTRACT

Twin bar (electro)magnets with the North poles facing each other generate magnetic field lines converging into the middle, providing a space to place plasma cloud in magnetic confinement for thermonuclear fusion experiments. Source materials are injected through nozzles connected to axial pipes, and end products are taken out at the periphery of the reaction chamber. In ion separation, the source materials are injected at the periphery of the reaction chamber causing rapid rotation, and ions are attracted by electric potentials applied to the chamber walls. Naturally separated ions are expelled through the axial output pipes. The proposed apparatus for ion separation provides inexpensive means for producing massive volumes of hydrogen and oxygen gases. Use of hydrogen fuel can reduce consumption of carbon fuels, easing the global problem of rising temperature due to emission of CO₂ gases.

### BACKGROUND OF INVENTION

### Field of Invention

The physical natures of a black hole can best be characterized using an unpublished physical model of proprietary information. The model uses twin magnetic dipoles with two of the same North poles juxtaposed facing each other using usual terminology. Given a bar magnet with N/S poles, the magnetic field lines are defined here to run through the body of the magnet from N to S pole, go outside the body of the magnet, and return to the N pole, completing closed circuits of apple-shaped dipole magnetic field lines running in multiple layers.

A sufficiently large black hole has such a magnetic dipole pair with properties of; (1) spiral converging movements of charged particles on the accretion disk due primarily to the gravitational pull right on the commonly shared plane of the dipole twins, (2) separation of charged particles on the accretion disc due to the handedness of charged particles in movement by inherent nature, and (3) generating two opposed dipole magnetic fields with magnetic fluxes pointed perpendicular to the accretion disk, ejecting accelerated charged particles and energetic photons away towards two opposite directions perpendicular to the accretion disk along the magnetic flux lines of the twin magnets.

Ion separation can be accomplished efficiently using the mechanism of (2) and (3).

Plasma confinement in laboratory can be achieved using the same mechanism by exploiting the thick inner lining of converging magnetic field lines to keep plasmas away from chamber walls between the two opposed North poles in place. To this date, no such technical feasibility has been investigated nor developed for practical applications.

### Description of the Prior Art

In the past nuclear fusion experiments, creation and maintenance of hot plasma stream had been considered essential for achieving sufficiently high plasma temperatures. However, use of the toroidal chamber of Tokamak can never escape from the plasma leakage problem due to (i) the unequal spacing of the poloidal magnets, surrounding the torus surface cross section-wise, which have different size separation distances between inside and outside curved wall surfaces, and (ii) the induced forces pointed sideway outwards by the interactions between charged ions moving inside and the vertically oriented applied poloidal magnetic field lines. Although various designs of Stellarator attempt to minimize the orbit migration problem, they have to deal with complex chamber designs which pose engineering problems with difficult implementations.

### SUMMARY OF INVENTION

Two high-strength dipole electromagnets (if needed, with cryogenically cooled superconductor coils added to the solenoids of electromagnets), or two permanent magnets of sufficient strengths, are juxtaposed with the North poles [sic] facing each other at a small separation distance. There is a particular small region, in which repelling magnetic field strengths against each other are small, at and near the mid-point between the two North magnetic poles, where all the converging magnetic field lines dip towards the poles on the surfaces. This is the location, at which the reaction chamber is placed either (a) for the plasma confinement or (b) for the ion separation.

A chamber in the shape of twin funnels fused at the mouth edges, made of heat resistant ceramic materials, is installed between the twin magnets with two axial funnel pipes extended outward along the center line of the aligned dipole magnetic fluxes. The axial piping is used for the dual purposes of either plasma injection in the plasma confinement (a), or the ion expulsion in the ion separation (b), using the same basic design.

In nuclear fusion experiments (a), the extended axial pipes are used for injection of pressurized deuteron/tritium gas after stripping electrons, through two, or more, injector nozzles (not shown) meeting at the center of the reaction chamber for high density plasma collisions. The chamber has ejection port(s) at the periphery of the reaction chamber for expulsion of helium at the end of each fusion experiment cycle. A natural separation of helium from the deuterium and tritium is achieved using the prevailing principle of diffusion process mass separation.

In the ion separation (b), the same two extended axial pipes are used for expulsion of accelerated ions pushed outwards by the magnetic field fluxes. Nozzles at multiple ports for injecting source materials are placed at the periphery of the reaction chamber with all injection nozzles (not shown) pointed to the direction of the plasma rotation on the periphery of the chamber.

Fusion experiments (a): The plasma lumps are kept away from direct contact with the chamber walls by the strong converging dipole magnetic field lines, which are by design rapidly rotated through addition of circular magnetic field components of a chosen rotational direction. Circularly positioned solenoids, or circular arrays of permanent magnets, are placed outside of the reaction chamber on both top and bottom sides. The converging magnetic field lines naturally push the plasma lumps towards the middle of the chamber increasing chance of plasma collisions to induce nuclear interaction.

Since the rotating high density plasma clouds contain both positive and negatively charged particles, they are pulled towards the two opposed poles due to the handedness in movements of given charges, but externally applied gas pressures through the injection pipes push them back towards the center of the chamber. In the process, the plasmas in helical movements in very small orbits of rotation frequently collide against each other surrounded by the converging magnetic field lines. Through repeated collisions, atomic nuclei become bare, exposing individual protons and neutrons. Bared nucleons collide and may interact to fuse. When input plasmas consist of deuterium, or tritium, the high-energy collisions are expected to increase chances of fusing the atoms together. Accumulated end-product, helium, can be removed at the chamber's periphery using the principle of natural diffusion process mass separation in actual progress.

The above apparatus design completely eliminates the orbiting plasma migration problems encountered in torus Tokamak design, and avoids the complicated chamber designs of Stellarators. The converging movements of enclosed plasmas inside the reaction chamber increases the chance of nuclear interactions more than those currently achievable in hot plasma streams of Tokomak.

To make use of heat generated through potential nuclear fusions, the reaction chamber must be directly attached to the radially installed ferric core plates of the twin electromagnets, which act as heat radiator fins. In case of permanent magnets, radiator fins must directly be mounted onto the outer surfaces of the reaction chamber. The entire apparatus in tight water seal can be submerged inside water vessel of a pressurized boiler as the heat source, from which condensed high pressure steam output may be obtained (or through liquid salt bath in heat exchanger).

Ion separation (b): Ions are naturally separated into two layers of charged particle groups in circular movement, and are pushed outward through the centerline magnetic flux cores of the twin magnets. To promote separation of charged particles, the top and bottom half surfaces of the chamber walls are designed to have positive and negative potentials applied to overlaid leads or conductor plates on either inside or outside surfaces of the chamber walls so as to facilitate ion separation into two layers of opposite charge groups in fast rotations.

Positively and negatively charged ions in mixture, or still in bound molecular states, are directly injected into the reaction chamber from the periphery after striping electrons through a set of multiple injection nozzles all pointed to the direction of plasma group rotations.

The separated ions still in spiral motion are accelerated and ejected through the axial expulsion pipes at the core centerlines of the twin magnets. The process can yield high volume ion separation due to the simple and effective design features of the apparatus. If powerful permanent magnets are used, no electrical power of sizable amount is needed to produce separated ions.

Although unverified through laboratory testing, the ion separation technique is considered more energy efficient than the standard method of electrolytic separation of hydrogen and oxygen gases out of H₂O. Once hydrogen and oxygen gases are produced using the apparatus, they can be recombined in a sealed internal combustion engine-reactor of choice. The engine power output can be utilized for locomotion or electric power generation purposes.

Since preparation of the atomic fuel elements, deuterium and tritium, are very expensive, the option of hydrogen-oxygen gas generation from H₂O with recombination thermal rector engine may be a more economical means of operating the apparatus for industrial applications.

Such an application can lead to reduction of carbon fuel consumption for electrical power generation, resulting in reduced emission of CO₂ from smoke stacks of power stations.

For large size installations for electrical power generation, the entire apparatus as a unit may have to be installed horizontally inside a heavy concrete coffin casing so as to resist and contain the strong repulsive forces generated by the opposing magnetic field lines.

### EXAMPLE

Although invisible to astronomers, the physical characteristics of the extremely large size black hole at the center of Milky Way galaxy is sufficiently adequate as an indirectly observable inferred functional example to be quoted from the cosmic observations of black holes.

Milky Way galaxy has two magnetic spheres called Fermi spheres of 200,000 light years across above and below the galactic plane. Inside the spheres accelerated energetic charged particles ejected from the black hole collide with free floating particles and produce gamma ray photons. These charged particles are accelerated by the dipole magnetic fluxes of the twin dipole magnets as specified in this specification. The observed phenomenon of the charged particles in high degree of acceleration has famously been called the ‘synchrotron effect’ of a black hole

The invented apparatus in this specification is a miniature laboratory version of the large size black hole in the simplified instrument design configuration.

### OBJECT OF INVENTION

The primary objective of the invention is to find an adequate means for generating high density, high temperature plasma clouds in order to explore technical feasibility of nuclear fusion in laboratory set-up. The device provides an alternative to the 15 mega-amps International Thermonuclear Experimental Reactor (ITER) Tokamak installation under construction in France, if the big budget effort fails as previously experienced at National Injection Facility (NIF), Livermore, Calif.

The second objective of equal or greater importance is the design specification of an apparatus for ion separation of ion mixture, or of those still in bound molecular state. As an example, if water vapor is injected after stripping electrons, positively charged hydrogen ions and negatively charged (OH)⁻ and the resulting oxygen ions may be separated, and ejected as twin gas outputs. Hydrogen and oxygen molecular gases can be recombined to restore the H₂O in suitable reactor-engines of choice for recycling.

If the hydrogen/oxygen gases can easily be produced in mass without using large amounts of electricity by the designated apparatus of the specification, the reactor engine power output for recombination in restoring H₂O can be utilized for electrical power generation without relying on coal fuel for the steam powered electric power generators as currently practiced in the power industry. This can contribute to reduction of CO₂ emissions into atmosphere.

### BRIEF DESCRIPTION OF THE DRAWINGS

FIG. 1 shows a sectional cut-away view of the basic physical configuration of the apparatus, comprising two electromagnets 1 in cylindrical shape, juxtaposed with the North poles [sic] facing each other. [The electromagnets can be substituted by permanent magnets of sufficient strengths.] The shown outside frame is of ferric plates 2 with sections cut out open for insertion of a pressure resistant reaction chamber 4 in the shape of fused twin funnels positioned between the two North poles facing each other. Since the two electromagnets repel against each other, strong casing and containment bracing may be needed to hold the two magnets together in position, particularly in a large system installations, although not illustrated in the diagram.

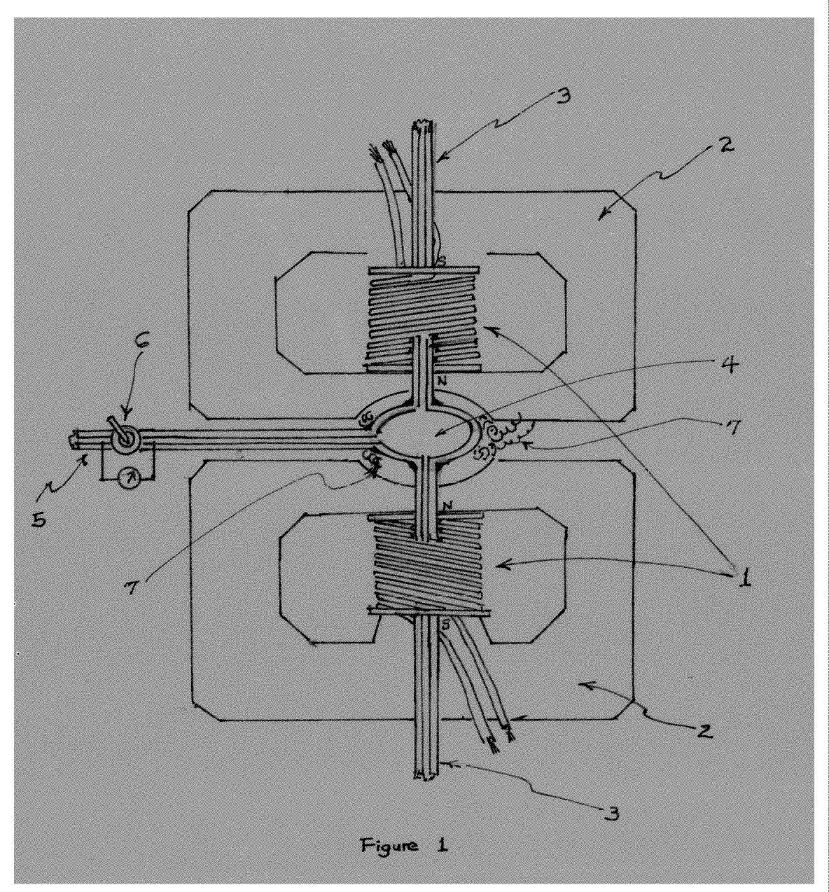

Each electromagnet 1 contains a pipe 3 placed along the centerline, for the plasma injection in the plasma confinement (a) [for the ion expulsions in the ion separation (b)]. Two standard solenoids of the electromagnets 1 have the reaction chamber 4 sandwiched in-between. The ferric plates 2 function as promotor of magnetic field line circulation as well as thermal radiator fins as installed in multiple radial orientations in the case of nuclear fusion experiments (a). On the left side, a helium exhaust pipe 5 is installed in the plasma confinement (a) [as ion injection pipe 5 in the ion separation (b)] with a pressure regulator valve 6 installed. Circularly placed solenoids 7 surrounds the reaction chamber to provide rapid rotation of enclosed plasmas. The solenoids 7 can be substituted by circular arrays of permanent magnets surrounding the reaction chamber.

In plasma confinement (a), pressurized source material clouds are pushed in from the two ends of the injection pipes 3 and through spherically arranged multiple nozzles [not shown] inside the reaction chamber 4 to keep compressed cloud of plasmas away from the chamber walls and to have plasmas collide inside the smallest possible spherical volume in the highest possible plasma density. During the operation, the pressure regulator valve 6 is kept closed to maintain the pressurization inside the reaction chamber 4. If nuclear fusion ever occurs, the end product helium atoms are expelled through the expulsion pipe 5 based on the diffusion process mass separation of the heavier helium atoms spun away from the chamber center.

In ion separation (b), the source material, either ion mixture, or still in bound molecular state, is injected into the reaction chamber 4 through multiple nozzles [not shown], all pointed to the direction of rotating ion cloud, under pressurization, and connected to the input pipe 5. The ion cloud separate naturally into two layers of opposed charges inside the chamber 4. To facilitate the ion separation, electric leads or plates can be placed either inside or exterior of the chamber wall of 4 to apply positive and negative potentials respectively on the opposed top/down side chamber walls. The accelerated separated ions, possibly in combined molecular form already, can be taken out through the expulsion pipes 3 aligned along the centerline of the twin magnets 1.

### DESCRIPTION OF THE PREFERRED EMBODIMENT

In the current designs of Tokamak and Stellarators, plasma streams are generated inside and accelerated to raise the orbiting speeds and temperatures of plasma lumps inside the respective confinement chambers. Plasmas in rapid motion through applied directional magnetic fields must face natural drifting path problems due to the unavoidable interaction between the plasma orbital motion and the applied poloidal magnetic fields.

The invented apparatus confines plasma cloud at the center of a closed round chamber 4 in high density, and rapidly rotates the densely-packed plasmas to raise temperature through high rotation rates using circularly positioned solenoids 7, or circular arrays of permanent magnet in the place. This eliminates the path drift problems.

The apparatus design calls for the second purpose of separating positively and negatively charged ionized bodies. This mode of application provides an excellent means for yielding massive and inexpensive hydrogen fuel. It can reduce the current total dependence on carbon fuels, and can lead to easing of the serious global climate problem of rising temperature due to heavy CO₂ emissions on Earth.

### Summary of the Achievement of the Objects of the Invention

From the foregoing, it is apparent that an apparatus for dual purposes of (a) plasma confinement and (b) ion separation has been defined and proposed. It can be used either for testing technical feasibility of nuclear fusion process in laboratory setting, or for practical ion separation, e.g., of water molecules into hydrogen and oxygen gases, on massive scales.

It is to be understood that the foregoing descriptions and special embodiments are merely illustrative of the best mode of the invention, and the principles thereof, and various modifications, and additions made to the apparatus design by those skilled in the art without departing from the spirit and scope of this invention, which is therefore understood to be limited by the scope of the apprehended claims.

1. A method of plasma confinement comprising:
utilizing identical twin electro-magnets in stacked form to establish thick layers of magnetic field lines converging into the opposed North poles within a closed chamber; and,
confining a plasma cloud within the magnetic field lines whereby the plasma does not contact walls of the closed chamber.

2. The method of claim 1 further comprising:
compacting the cloud in the smallest possible region at the highest possible density, and
rapidly rotating focused converging magnetic field lines of the twin electromagnets, thereby raising temperature of the confined plasma cloud in the closed chamber.

3. The method claim 1 further comprising:
applying opposed electrical potentials to overlaid conductive leads or plates inside or outside the chamber opposite sides;
making use of fast rotating and converging magnetic field lines thereby separating positively and negatively charged ions in mixture, or still in molecular states; and,
ejecting the separated ions through magnetic fluxes of magnetic cores of the electromagnets exploiting synchrotron effect particle acceleration.

4. The method of claim 2 wherein the step of rapidly rotating comprises:
installing circularly positioned solenoids, or placing circular arrays of permanent magnets, around the reaction chamber; and,
generating rotating magnetic field lines surrounding the chamber.

5. The method of claim 1 further comprising:
using mass diffusion for natural separation of fusion end product helium atoms at the periphery of the chamber; and,
injecting ion mixture or source molecules through injection nozzles installed at the same ports.

6. The method of claim 3 further comprising:
producing hydrogen and oxygen gas from the ion separation;
feeding the produced hydrogen and oxygen gas into a closed internal combustion chamber engine-reactor for recombination of H2O in recycling; and,
utilizing the engine power output for locomotion and/or for electric power generation purposes.

7. (canceled)

8. An apparatus for plasma confinement and for ion separation, comprising:
two juxtaposed solenoids of electromagnets, or permanent magnets, with the two North poles facing each other, and
a reaction chamber placed between the electromagnets or permanent magnets.

9. The apparatus for plasma containment and ion separation, as defined in claim 8, wherein the reaction chamber comprises two fused funnels of heat resistant ceramic materials, with each funnel connected to an extended pipe for injection of pressurized fresh plasma elements, and for ejection of separated ions.
